(19) United States
(12) Patent Application Publication
(10) Pub. No.: US 2011/0143069 A1
(43) Pub. Date: Jun. 16, 2011

(54) Method of Fabricating A Device Such As A Coupling By Laser Welding, The Device Fabricated By Such Method, And An Element Of Such Device For Implementing The Method

(76) Inventor: Philippe Blivet, Rennes (FR)

(21) Appl. No.: 13/010,114

(22) Filed: Jan. 20, 2011

Related U.S. Application Data
(63) Continuation of application No. PCT/FR2009/000849, filed on Jul. 9, 2009.

(30) Foreign Application Priority Data
Jul. 14, 2008 (FR) 0804212

(51) Int. Cl. B32B 37/06; B32B 7/04; B32B 3/30; B32B 27/06; B32B 1/08

(52) U.S. Cl. 428/36.9; 156/272.8; 428/198; 428/172; 428/411.1

(57) ABSTRACT

A method of fabricating a device such as a coupling, the device fabricated by such method, and an element of such device for implementing the method. The method includes two bodies assembled together by laser welding, one of the bodies including a lens for refracting the laser radiation onto the other body.

### CROSS REFERENCE TO RELATED APPLICATIONS

This application is a continuation of co-pending International Application No. PCT/FR2009/000849 filed Jul. 9, 2009, which designated the United States, and which claims priority to French Patent Application No. 0804212, filed Jul. 24, 2008; the disclosure of each of which is expressly incorporated herein by reference.

### BACKGROUND OF THE INVENTION

The present invention relates to a method of fabricating a device by implementing a laser welding operation. The invention also relates to such a device and to an element of such a device. By way of example, such an element is a coupling suitable for use in making a member of a fluid transport circuit, such as a member for delivering or receiving fluid.

Laser welding is a fastening method that is nowadays in widespread use for fastening together an element made of a material that is opaque to laser radiation and an element made of a material that is transparent to the laser radiation. When these elements are subjected to such radiation focused in a zone of mutual contact between the elements, the opaque element heats up under the effect of the laser radiation and also heats the transparent material by conduction. If the power of the radiation is sufficient, then the heating gives rise to local melting of the materials in the vicinity of the spot where the radiation is focused. A weld bead is formed by moving the elements relative to the spot where the radiation is focused.

The laser radiation comes from an optical assembly including a radiation source and one or more lenses for focusing the laser radiation. By way of example, the radiation source may be constituted by laser diodes. The focusing lens serves to focus the radiation in the desired weld zone and is optionally movable so as to create a weld bead. The focusing lens is particularly useful when laser diodes are used as the radiation source, since laser diodes produce a beam that diverges to a greater extent than the beams produced by conventional lasers of the yttrium aluminum garnet (YAG) or CO₂ type. The focusing lens is normally made of a material that is transparent to the radiation, but it inevitably includes impurities that react with the laser radiation, thereby leading in the long run to degradation of the optical properties of the lens, requiring it to be replaced. Lens-cooler devices are generally provided in order to avoid the lens heading under the effect of the laser radiation, since that would run the risk of damaging the lens. The lens should normally be as close as possible to the welding zone, but that runs the danger of the lens being flattened and makes it difficult to move the elements for welding together and to perform maintenance operations. Moving the lens is complex and requires the use of movable optical elements such as mirrors and prisms, serving to convey the radiation from the radiation source to the lens.

In order to obviate the last-mentioned difficulty, it is known to move the elements for welding relative to the lens. Nevertheless, such movement is sometimes not possible, in particular when one of the elements for assembling together presents a large dimension in at least one direction. This applies for example when welding a coupling to an end of a tube that is several meters long.

Furthermore, a change in the dimensions of the elements from one series of elements to another requires focusing to be adjusted in order to adapt to the dimensions of the new series.

### SUMMARY OF THE INVENTION

An feature of the invention is to enable all or some of the above drawbacks to be avoided. To this end, the invention relates to a method of fabricating first and second elements that are assembled together by laser welding, the first element being made of a material that is least partially opaque to laser radiation and the second element being made of a material that is transparent to the laser radiation and that includes a lens for refracting the radiation towards the first element in order to weld the first element to the second element when the first and second elements are applied one against the other and the laser radiation is directed towards the lens.

In an illustrative implementation of the method of the invention, with the device including the first and second elements in contact with each other via a contact surface, the method provides the steps of:
(a) making a body of the first element out of a material such that the body is at least partially opaque to laser radiation at least at the contact surface;
(b) making a body of a second element out of a material such that the body is transparent to the laser radiation at least between the contact surface and an inlet surface for admitting the laser radiation into the body, arranging a portion of the body to form at least one lens for refracting the laser radiation; and
(c) applying the contact surface of the second element against the contact surface of the first element and directing at least one source of laser radiation towards the inlet surface of the second element so as to melt the contact surface of the first element and weld the second element to the first element, the lens-forming portion being arranged to shape the laser radiation in at least one laser radiation impact zone on the contact surface.

The heating and melting of the contact surface of the first element acts by conduction to heat and melt the contact surface of the second element. The term “to shape” is used to mean any optical processing suitable for changing the shape, the density, or the energy distribution of the laser radiation in the zone in which the laser radiation impacts the contact surface. In the method of the invention, the lens is directly incorporated in one of the elements for welding together. The lens is thus placed as close as possible to the welding zone, but without that impeding movements of the elements for welding together or impeding maintenance operations. Also, the lens is used once only, and as a result it does not suffer significant wear. The optical properties of the lens need not be as good as those of a conventional external lens. Incorporating the lens in the second element provides at least partial correction of relative positioning errors in all six degrees of freedom of the elements relative to the source of radiation, thereby increasing the tolerance of the method with respect to such positioning errors and also with respect to variations in the dimensions of the elements. The radiation that does not pass through the lens also serves to increase the temperature of the first element and to reduce the temperature gradient at its contact surface between welded zones and non-welded zones.

Advantageously, the lens-forming portion is arranged to concentrate the laser radiation in the impact zone. The lens thus enables a spot weld to be made.

In a particular implementation, the lens-forming portion is arranged to produce a plurality of weld spots. The lens thus enables a plurality of weld spots to be implemented simultaneously from a single source of radiation. Under such circumstances, the lens-forming portion is advantageously arranged in such a manner that the weld spots overlap, and preferably each weld spot is elongate in shape. The lens as arranged in this way enables a continuous weld to be implemented.

The laser radiation may present a transverse dimension that is greater than a maximum transverse dimension of the lens-forming portion. It suffices to cause the elements applied against each other to move past the laser radiation, with the second element being oriented to face the laser radiation, and regardless of the angular orientation of the elements relative to the laser radiation. It is thus possible to perform welds in series while minimizing the constraints on positioning the elements relative to the laser radiation.

The invention also provides a device obtained by the method of the invention, the device including at least first and second elements in contact with each other via a contact surface and welded together at the contact surface, wherein:
(a) the first element has a body made of a material that is at least partially opaque to laser radiation at least at the contact surface; and
(b) the second element has a body made of a material that is transparent to the laser radiation at least between the contact surface and an inlet surface for admitting the laser radiation into the body, the body including a portion that forms at least one lens for refracting the laser radiation towards the contact surface of the first element.

The invention also provides an element used in fabricating such a device, the element having a body made of a material that is transparent to the laser radiation to which the body is to be subjected, the material being transparent to the laser radiation at least between an inlet surface for admitting the laser radiation into the body and an outlet surface for the laser radiation, the body including a portion fanning at least one lens for refracting the laser radiation so as to shape an impact zone for the laser radiation on a contact surface of another element that is applied against the outlet surface for the laser radiation.

The invention also provides a coupling including a body defining a chamber for receiving a tube end, the body being made of a material that is transparent to the laser radiation to which the body is to be subjected, the material being transparent to the laser radiation at least between an outside surface of the body and a wall of the chamber, the body including a portion forming at least one lens for refracting the laser radiation to form an impact zone of the laser radiation against an outside surface of a tube end that is received in the chamber.

Other characteristics and advantages of the invention appear on reading the following description of particular, non-limiting embodiments of the invention.

The present invention, accordingly, comprises the construction, combination of elements, and/or arrangement of parts and steps which are exemplified in the detailed disclosure to follow.

### BRIEF DESCRIPTION OF THE DRAWINGS

Reference is made to the accompanying drawings, in which:

FIG. 1 is a diagrammatic perspective view showing the principle of a welding operation in a first implementation of the method of the invention;

FIG. 2 is a diagrammatic section view on plane II of FIG. 1;

FIG. 3 is a view analogous to FIG. 1 showing a first variant implementation;

FIG. 4 is a view analogous to FIG. 1 showing a second variant implementation;

FIG. 5 is a view analogous to FIG. 1 showing the principle of a welding operation in a second implementation of the method;

FIG. 6 is a diagrammatic section view on plane VI of FIG. 5;

FIG. 7 is a diagrammatic perspective view showing a welding operation in a third implementation;

FIG. 8 is a perspective view showing the application of the first implementation to welding a coupling on a tube end, the first variant being shown in the left-hand portion of the coupling and the second variant in the right-hand portion; and

FIG. 9 is a fragmentary section view on plane IX of FIG. 8.

The drawings will be described further in connection with the following Detailed Description of the Invention.

### DETAILED DESCRIPTION OF THE INVENTION

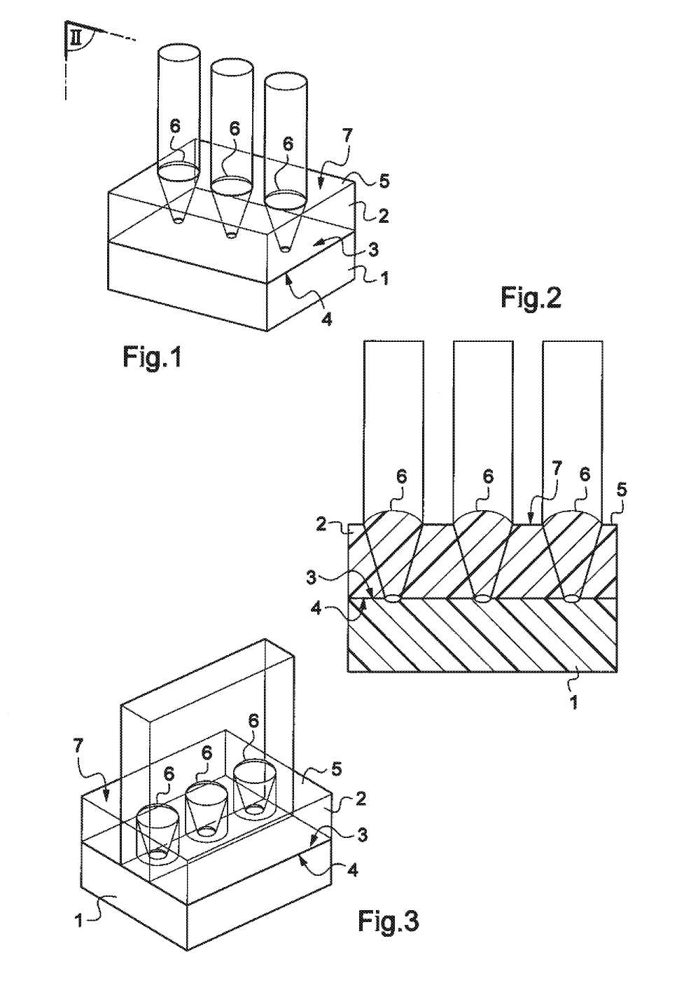

With reference to FIGS. 1 and 2, the method in accordance with the invention is for fabricating a device including at least a first element 1 and a second element 2, here in the form of plates, which elements are in contact with each other via a contact surface 3, 4.

The method includes a step of fabricating the elements 1 and 2, and a step of welding the elements 1 and 2 together by means of laser radiation.

The method of the invention begins by making the elements 1 and 2.

In this example, the first element 1 is made using a conventional method of injecting a thermoplastic material into a mold (not shown) so as to form the body of the first element 1. The material used is a material that is opaque to laser radiation.

In this example, the second element 2 (shown for greater clarity as being transparent in FIG. 1 and also more generally in the perspective views) is made using a conventional method of injecting a thermoplastic material into a mold (not shown) so as to form the body of the second element 2. The material used is a material that is transparent to laser radiation. The mold has a cavity that is arranged to form lenses 6 on a portion 5 of the body of the second element 2, the lenses 6 serving to focus the laser radiation. The lens 6 is present on a surface 7 of the body that is opposite from the contact surface 4 and, in this example, parallel thereto.

The thermoplastic materials used are naturally suitable for welding to each other. Specifically, the same material is used for both elements. This material, which is naturally transparent to the laser radiation, is made opaque for the first element by incorporating therein a filler such as a carbon black.

Once the elements 1 and 2 have been fabricated, the contact surface 4 of the second element 2 is applied against the contact surface 3 of the first element 1. A source 8 of laser radiation, in this example a strip of laser diodes, is directed towards the surface 7. The laser radiation is of the infrared type and includes a plurality of parallel beams, each directed towards a respective one of the lenses 6. Each lens 6 focuses the laser radiation onto the contact surface 3 of the first element 1 in such a manner as to melt the contact surface 3 of the first element 1. The heat as produced in this way is transferred by conduction to the contact surface 4 of the second element 2, thereby melting the second contact surface 4 and welding the second element 2 to the first element 1. The force applied on these elements serves to control interpenetration of the materials and tangling of their macromolecular chains.

It should be observed that the surface 7 forms an inlet surface for admitting laser radiation into the second element 2, and the contact surface 4 forms an outlet surface for allowing laser radiation to leave the second element.

In this example, each lens 6 is of convex shape so as to concentrate the laser radiation on a small zone of the contact surface 3 so as to enable melting to take place quickly while using relatively low power. More precisely, each lens 6 presents an elliptical profile being wider than it is tall so as to modify the distribution of the energy of the laser radiation in the impact zone of the laser radiation on the contact surface 3 by concentrating the energy in the center of the impact zone. The lenses 6 thus produce a plurality of melt spots that are spaced apart from one another.

The lens 6 may be elongate in shape parallel to the surface 7 so that relative movement between the elements and the laser radiation then serves to subject the entire lens 6 to laser radiation. Relative movement is obtained by moving the outlet of the laser radiation source along the lens 6, or by moving the elements relative to the outlet from the laser radiation source. This enables a continuous weld to be obtained.

In a variant, as shown in FIG. 3, the laser radiation is produced in the form of a single beam of rectangular section that covers a plurality of lenses 6.

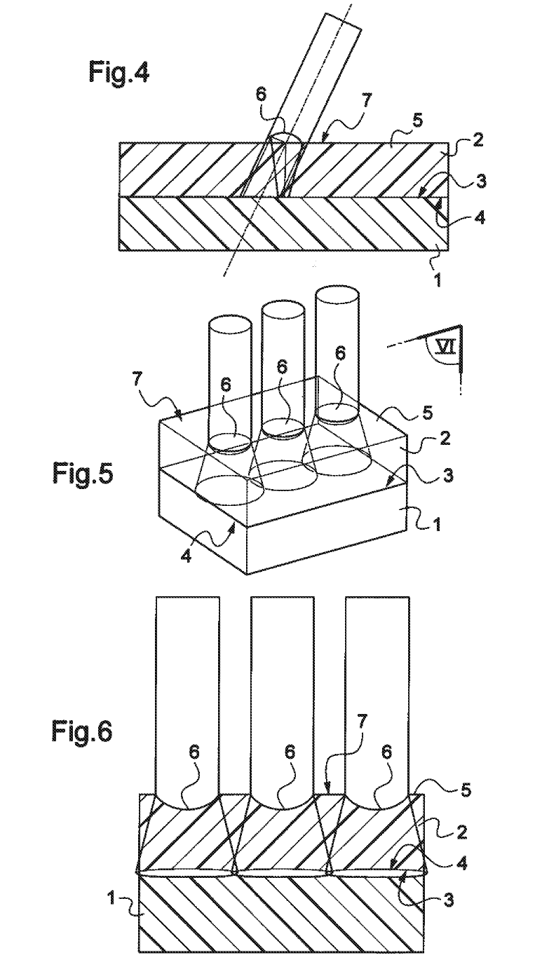

In another variant shown in FIG. 4, the laser radiation is emitted onto the lenses 6 along a direction that is inclined relative to the contact surface 3, 4.

Elements that are identical or analogous to those described above are given numerical references identical thereto in the description below of second and third implementations.

In the second implementation shown in FIGS. 5 and 6, the lenses 6 are of concave shape so as to spread the laser beam they transmit so as to produce welding spots that overlap in part in order to form a continuous weld.

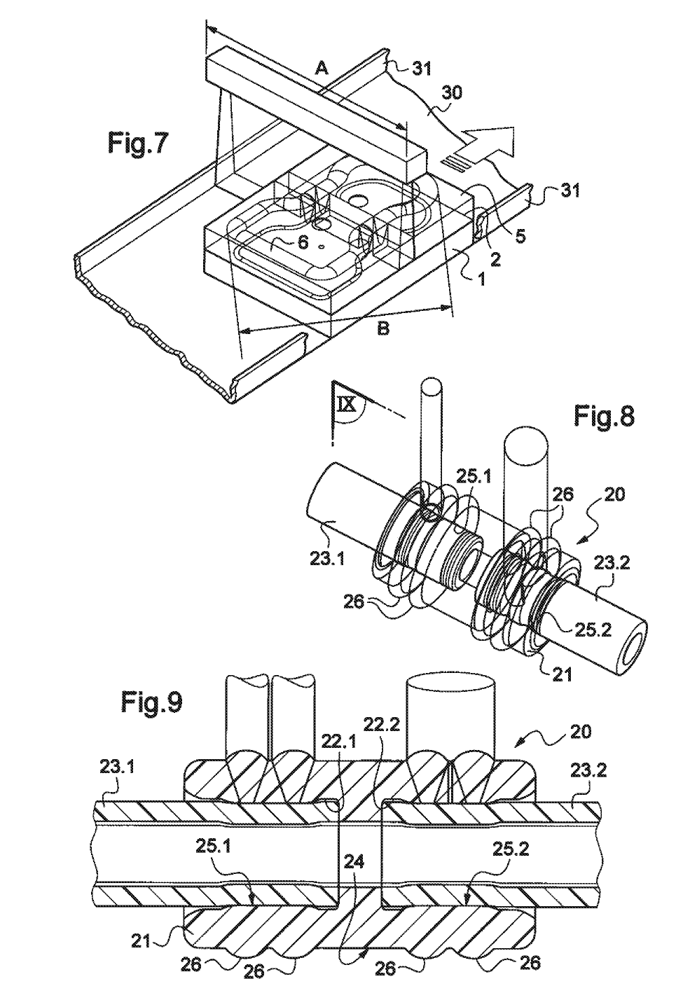

In the third implementation shown in FIG. 7, the lens 6 is elongate in shape and extends along a closed line. The lens 6 thus presents the shape of the weld bead that is to be made. The source of laser radiation is arranged to form laser radiation in the form of a sheet of section that, in this example, is rectangular so that the laser radiation presents a transverse dimension A (length of the rectangular section) that is greater than the maximum transverse dimension B of the portion 5 forming the lens 6. This enables a weld bead to be made by causing the superposed elements 1 and 2 to travel past the laser radiation without it being necessary for the elements to be oriented in any particular direction.

The dimension A in this example is equal to the greatest dimension of the device. The elements 1 and 2 applied one against the other are placed on a conveyor belt 30 that passes under the source of radiation. The belt 30 in this example has edges 31 that are spaced apart by a distance that is equal to the dimension A.

It can be understood that the devices formed by the elements 1 and 2, with the elements 2 facing towards the source of laser radiation may be placed on the conveyor belt in arbitrary orientations.

There follows a description of how the method of the first implementation of the invention can be applied to a coupling.

The coupling 20 includes a body 21 defining respective chambers 22.1 and 22.2 at each of its ends for receiving respective tube ends 23.1 and 23.2.

The body 21 is made of a material that is transparent to the laser radiation to which the body is to be subjected while performing the fabrication method. The material is transparent to the laser radiation, at least between an outside surface 24 of the body and a wall 25.1, 25.2 of the chamber 22.1, 22.2. The body 21 includes a portion forming at least one lens 26 for focusing the laser radiation into the chamber 22.1, 22.2 in the proximity of the wall 25.1, 25.2.

In this example, there are two lenses 26 at each end of the body 1, each of them being in the form of a convex annular bulge serving to focus the laser radiation and to spread it in a circumferential direction of the wall 25.1, 25.2.

The tube ends 23.1, 23.2 are engaged as force fits in the chambers 22.1, 22.2 so that the outside surface of each tube end 23.1, 23.2 is pressed with pressure force against the corresponding wall 25.1, 25.2 of the chambers 22.1, 22.2.

Laser radiation including a beam for each of the lenses 26 (chamber 22.1) or laser radiation for both lenses 26 (chamber 22.2) is then emitted in a radial direction of the coupling 20 onto the lenses 26. The focus spots lie on the outside surfaces of each of the tube ends 23.1, 23.2.

By rotating the coupling or by moving the radiation source circularly around the coupling 20, a continuous weld is obtained between each tube end 23.1, 23.2 and the corresponding wall 25.1, 25.2 of the chambers 22.1, 22.2. Since the focus spots of the beams are elongate in shape in a circumferential direction of the chambers 22.1, 22.2, the rotation or the circular movement is limited. It is also possible to use a plurality of radiation sources that are distributed around the coupling 20. By way of example, it is possible to use six sources that are placed at 60° intervals relative to one another.

It should be observed that by multiplying the number of lenses and by providing a plurality of sources of laser radiation, it is possible to make welds at a plurality of locations on the elements without moving either the sources or the elements.

It should also be observed that the surface 24 forms an inlet surface for admitting laser radiation into the coupling, and the wall 25.1, 25.2 forms an outlet surface allowing laser radiation to leave the coupling.

Naturally, the invention is not limited to the implementations described and covers any variant coming within the field of the invention as defined by the claims.

The body of the first element may be partially opaque, at least at the contact surface, and the body of the second element may be partially transparent, but at least between the contact surface and an inlet surface for admitting laser radiation into the body.

The lens-forming portion may comprise one or more lenses. The portion forming the lens 6 is arranged to produce a weld spot or a plurality of weld spots that are optionally overlapping. Each impact zone forming the weld spots may have a shape that is circular, elongate, or some other shape.

The lens may also have a profile forming a portion of a circle or of a parabola.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

What is claimed is:

1. A method of making a device comprising a first body and a second body, the method comprising the steps of:
(a) providing the first body as having a first contact surface, the first body being formed of a first thermoplastic material such that the first body is at least partially opaque to laser radiation at least at the first contact surface;
(b) providing the second body as having a second contact surface and an exposure surface opposite the second contact surface, the second body being formed of a second thermoplastic material such that the second body is at least partially transparent to laser radiation at least between the exposure surface and the contact surface, and the exposure surface being formed as having one or more lens portions for focusing laser radiation directed on the exposure surface towards the second contact surface;
(c) disposing one of the first and second contact surfaces against the other one of the contact surfaces; and
(d) directing at least one source of laser radiation on the exposure surface of the second body,
whereby the laser radiation from the source is focused through each of the lens portions of the exposure surface of the second body onto a zone of the first contact surface of the first body corresponding to each one of the lens portions so as to melt the first thermoplastic material in each such zone and to effect the welding in each such zone of the first body to the second body.

2. The method of claim 1 wherein each of the lens portions of the exposure surface of the second body is formed as having a generally concave or convex shape.

3. The method of claim 1 wherein the exposure surface of the second body is formed as having a plurality of such lens portions.

4. The method of claim 3 wherein the lens portions are arranged such that each such zone overlaps another such zone.

5. The method of claim 1 wherein one of the lens portions of the exposure surface of the second body is formed as having a generally elongate length.

6. The method of claim 5 further comprising the additional step during step (d) of moving the source of the laser radiation or the first and the second body relative to the other to expose substantially the entire length of the one of the lens portions to the laser radiation.

7. The method of claim 5 wherein the length defines a closed line.

8. The device made by the method of claim 1.

9. The method of claim 1 wherein:
the device is a coupling assembly;
the first body is provided in step (a) as a tube member having a tube end, the tube end having an outer tube surface defining the first contact surface;
the second body is provided in step (b) as a coupling member having a socket end, the socket end having an inner socket surface defining the second contact surface, and an outer socket member surface defining the exposure surface; and
the one of the first and second contact surfaces is disposed against the other one of the contact surfaces in step (c) by receiving the tube end of the tube member coaxially in the socket end of the coupling member.

10. A device comprising:
a first body having a first contact surface, the first body being formed of a first thermoplastic material such that the first body is at least partially opaque to laser radiation at least at the first contact surface; and
a second body having a second contact surface disposed against the first contact surface of the first body, and having an exposure surface opposite the second contact surface, the second body being formed of a second thermoplastic material such that the second body is at least partially transparent to laser radiation at least between the exposure surface and the contact surface, and the exposure surface being formed as having one or more lens portions for focusing laser radiation directed on the exposure surface towards the second contact surface and onto a zone of the first contact surface of the first body corresponding to each one of such lens portions so as to melt the first thermoplastic material in each such zone and to effect the welding in each such zone of the first body to the second body,
whereby the first body is welded to the second body in each such zone.

11. The device of claim 10 wherein each of the lens portions of the exposure surface of the second body is formed as having a generally concave or convex shape.

12. The device of claim 10 wherein the exposure surface of the second body is formed as having a plurality of such lens portions.

13. The device of claim 12 wherein the lens portions are arranged such that each such zone overlaps another such zone.

14. The device of claim 10 wherein one of the lens portions of the exposure surface of the second body is formed as having a generally elongate length.

15. The device of claim 14 wherein the length defines a closed line.

16. The device of claim 10 wherein:
the device is a coupling assembly;
the first body is tube member having a tube end, the tube end having an outer tube surface defining the first contact surface;
the second body is a coupling member having a socket end, the socket end having an inner socket surface defining the second contact surface, and an outer socket member surface defining the exposure surface; and
tube end of the tube member is received coaxially in the socket end of the coupling member to dispose the second contact surfaces against the first contact surface.

17. A member for a device comprising the member and another member including a first body having a first contact surface, the first body being formed of a first thermoplastic material such that the first body is at least partially opaque to laser radiation at least at the first contact surface, the member comprising:
a second body having a second contact surface disposable against the first contact surface of the first body, and having an exposure surface opposite the second contact surface, the second body being formed of a second thermoplastic material such that the second body is at least partially transparent to laser radiation at least between the exposure surface and the contact surface, and the exposure surface being formed as having one or more lens portions for focusing laser radiation directed on the exposure surface towards the second contact surface and onto a zone of the first contact surface of the first body corresponding to each one of such lens portions so as to melt the first thermoplastic material in each such zone and to effect the welding in each such zone of the first body to the second body,
whereby the first body is weldable to the second body in each such zone by laser radiation being directed on the exposure surface of the second body.

18. The device of claim 17 wherein each of the lens portions of the exposure surface of the second body is formed as having a generally concave or convex shape.

19. The device of claim 17 wherein the exposure surface of the second body is formed as having a plurality of such lens portions.

20. The device of claim 19 wherein the lens portions are arranged such that each such zone overlaps another such zone.

21. The device of claim 17 wherein one of the lens portions of the exposure surface of the second body is formed as having a generally elongate length.

22. The device of claim 21 wherein the length defines a closed line.

23. The device of claim 17 wherein:
the device is a coupling assembly;
the first body is tube having a tube end, the tube end having an outer tube surface defining the first contact surface;
the second body is a coupling having a socket end, the socket end having an inner socket surface defining the second contact surface, and an outer socket member surface defining the exposure surface; and
tube end of the tube is received coaxially in the socket end of the coupling to dispose the second contact surfaces against the first contact surface.
